(19) United States
(12) Patent Application Publication
(10) Pub. No.: US 2008/0118090 A1
(43) Pub. Date: May 22, 2008

(54) SURROUND ATTACHMENT

(76) Inventor: Daniel John Sheehan, Holliston, MA (US)

Correspondence Address: FISH & RICHARDSON PC, P.O. BOX 1022, MINNEAPOLIS, MN, 55440-1022, US

(21) Appl. No.: 11/562,576

(22) Filed: Nov. 22, 2006

(51) Int. Cl. H04R 25/00

(52) U.S. Cl. 381/150

(57) ABSTRACT

A mechanically interlocked acoustic radiator/surround assembly is disclosed wherein an edge of the acoustic radiator includes a protrusion extending from and/or a depression in a surface of the acoustic radiator. An elastomeric material is formed around the protrusion and/or fills the depression forming a radiator/surround interface that is not parallel to the surface of the acoustic radiator.

### BACKGROUND OF THE INVENTION

The present invention relates to suspension systems for acoustic transducers and methods for the manufacture of same. More specifically, the invention relates to the attachment of a surround to a diaphragm of an electro-acoustic transducer.

A surround provides support for an acoustic radiator as the acoustic radiator moves relative to a housing of an acoustic driver. A portion of the surround is attached to the housing and a second portion of the surround is attached to the acoustic radiator. The surround is typically attached to the acoustic radiator by an adhesive applied to a lap joint. The repeated cyclic stress experienced by the joint can contribute to a premature failure of the lap joint. Therefore, there remains a need for improved methods of attaching a surround to the acoustic radiator.

### SUMMARY OF THE INVENTION

A mechanically interlocked acoustic radiator/surround assembly is disclosed wherein an edge of the acoustic radiator includes a protrusion extending from and/or a depression in a surface of the acoustic radiator. An elastomeric material is formed around the protrusion and/or fills the depression forming an radiator/surround interface that is not parallel to the surface of the acoustic radiator.

One embodiment of the present invention is directed to an assembly comprising: an acoustic radiator having a first surface and an outer portion of the first surface, the outer portion having at least one protrusion extending from the first surface, the at least one protrusion characterized by a protrusion surface; and a surround in contact with the outer portion of the first surface forming a first interface, the surround in contact with the at least one protrusion forming a second interface, wherein the second interface provides a mechanical interference in a radial direction. In some aspects, the protrusion may be a discrete structure such as, for example, a post. In some aspects, the protrusion may be a continuous ridge along an edge of the acoustic radiator. In a further aspect, the acoustic radiator further comprises a second surface opposite the first surface and at least one protrusion extending from the second surface, the at least one protrusion extending from the second surface in contact with the surround and forming a third interface with the surround, the third interface oriented non-parallel to the first interface. In some aspects, the at least one protrusion extending from the second surface is different from the at least one protrusion extending from the first surface. In some aspects, the acoustic radiator further comprises a second surface opposite the first surface and at least one depression in the second surface, the at least one depression in contact with the surround and forming a third interface with the surround, the third interface having a non-parallel orientation to the first interface. In some aspects, the depression may be a discrete structure such as, for example, a blind hole. In some aspects, the depression is a continuous groove along an edge of the acoustic radiator.

Another embodiment of the present invention is directed to an assembly comprising: an acoustic radiator having an outer portion, the outer portion having a first surface and a second surface; a surround in contact with the first and second surface of the outer portion of the acoustic radiator; and a first protrusion extending from the first surface of the acoustic radiator, the first protrusion in contact with the surround. In one aspect, the assembly further comprises a second protrusion extending from the second surface of the acoustic radiator, the second protrusion in contact with the surround. In one aspect, the first protrusion is a post. In another aspect, the first protrusion is a ridge extending along an edge of the acoustic radiator. In one aspect, the assembly further comprises a depression in the second surface filled by the surround. In one aspect, the depression is a groove.

Another embodiment of the present invention is directed to an assembly manufactured by a process comprising the steps of: providing an acoustic radiator having an outer portion and at least one protrusion extending laterally from a surface of the outer portion of the acoustic radiator; placing the outer portion of the acoustic radiator in a mold, the mold defining a cavity enclosing the outer portion of the acoustic radiator; introducing a thermoplastic elastomer into the mold cavity, the thermoplastic elastomer filling the cavity and forming an interface with the surface of the outer portion of the acoustic radiator and with the at least one protrusion; and removing the assembly from the mold, wherein the acoustic radiator is mechanically interlinked with a surround, the surround comprising the thermoplastic elastomer introduced into the mold cavity. In one aspect, the at least one protrusion is a post. In one aspect, the at least one protrusion is a ridge along an edge of the acoustic radiator. In one aspect, the ridge extends continuously along the edge of the acoustic radiator. In one aspect, the outer portion includes at least one depression. In one aspect, the depression is a blind hole. In one aspect, the depression is a groove. In one aspect, the groove is continuous.

### BRIEF DESCRIPTION OF THE DRAWINGS

The invention will be described by reference to the drawings in which:

FIG. 1 is a cross-sectional view of an embodiment of the present invention;

FIG. 2 is a partial sectional view of another embodiment of the present invention;

FIG. 3 is a cross-sectional view of another embodiment of the present invention;

FIG. 4 is a cross-sectional view of another embodiment of the present invention;

FIG. 5 is a cross-sectional view of another embodiment of the present invention;

FIG. 6 is a cross-sectional view of another embodiment of the present invention;

FIG. 7 is a cross-sectional view of another embodiment of the present invention;

FIG. 8 is a cross-sectional view of another embodiment of the present invention;

FIG. 9 is an exploded perspective view of another embodiment of the present invention;

FIG. 10a is an illustration of an inner surface of a bottom portion of a mold for use with the embodiment shown in FIG. 9; and

FIG. 10b is an illustration of an inner surface of a bottom portion of a mold shown in FIG. 10a.

### DETAILED DESCRIPTION

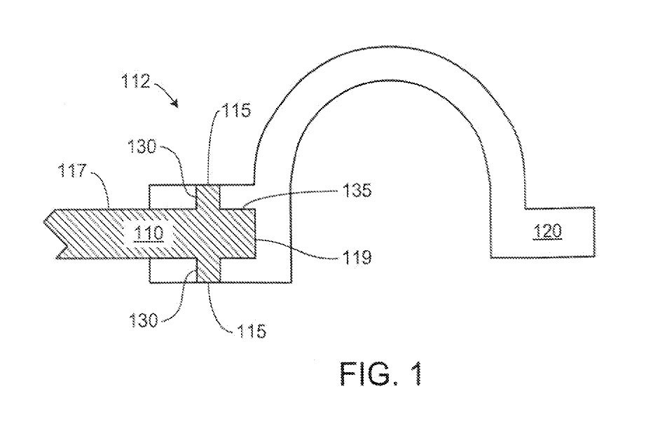

FIG. 1 is a cross-sectional view of an embodiment of the present invention. In FIG. 1, acoustic radiator 110 is interlocked with a surround 120. The surround 120 is preferably an elastomer that can be formed over the outer portion 112 of the acoustic radiator 110 where the surround 120 overlaps the edge of the acoustic radiator 110. As used herein, an acoustic radiator is the moving portion of an acoustic driver that generates an acoustic signal. Acoustic radiators include diaphragms in electro-acoustic transducers and moving plates in passive radiators. As used herein, an acoustic driver converts an input signal into an acoustic signal. Acoustic drivers include electro-acoustic transducers that convert an electrical signal into an acoustic signal. Acoustic drivers include passive radiators that convert a pressure signal in a first volume into an acoustic signal in a second volume.

The acoustic radiator 110 may be any structure that converts mechanical energy to acoustic energy. The acoustic radiator 110 may be actively driven by an electromagnetic voice coil, for example, or may be a passive radiator.

Interlocking of the surround and acoustic radiator may be accomplished by forming the surround around at least one protrusion extending from at least one face of the acoustic radiator. In FIG. 1, protrusions 115 are preferably posts laterally oriented to a face 117 of the acoustic radiator and are located inward from the acoustic radiator's edge 119. The posts may be located within the outer portion of the acoustic radiator 110 such that sufficient surround material remains radially inward of the protrusion to provide a mechanical interference in the radial direction that prevents radial movement of the surround outward from the protrusion. The posts may be circumferentially spaced around the acoustic radiator's perimeter.

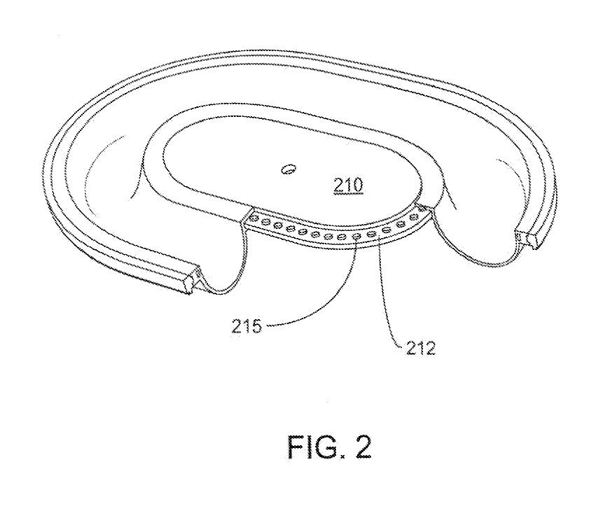

FIG. 2 is a partial section view of a surround/acoustic radiator assembly illustrating the circumferential spacing of protrusions 215 around the outer portion 212 of the acoustic radiator 210.

Protrusions 115 provide radiator/surround interfaces 130 that are not parallel to the radiator/surround interface 135. In prior radiator/surround assemblies, an adhesive is typically required to bond the radiator to the surround to prevent the surround from separating from the radiator during operation of the assembly. The adhesive, however, must be compatible with, and bond to, both of the surround and radiator materials. This compatibility requirement often limits the composition of the surround and/or the acoustic radiator.

Without being limiting, it is believed that the introduction of an interface 130 that is not parallel to a surface of the outer portion of the acoustic radiator 110 creates a mechanical interference that exhibits increased resistance to fatigue-induced failure during operation of the assembly. Furthermore, the mechanical interference may eliminate the need for an adhesive to bond the radiator/surround interface.

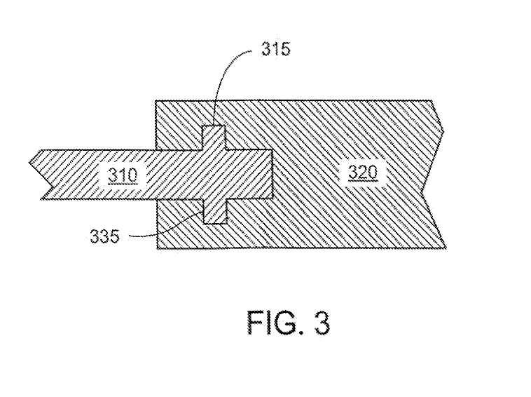

FIG. 3 is a cross-sectional side view of another embodiment of the present invention. In FIG. 3, a non-parallel interface 335 is provided by a continuous ridge 315 around the circumference of the acoustic radiator 310. The radial placement of the continuous ridge 315 may be at any distance within the outer portion of the acoustic radiator 110 such that sufficient surround material remains radially inward of the continuous ridge 315 to provide a mechanical interference in the radial direction.

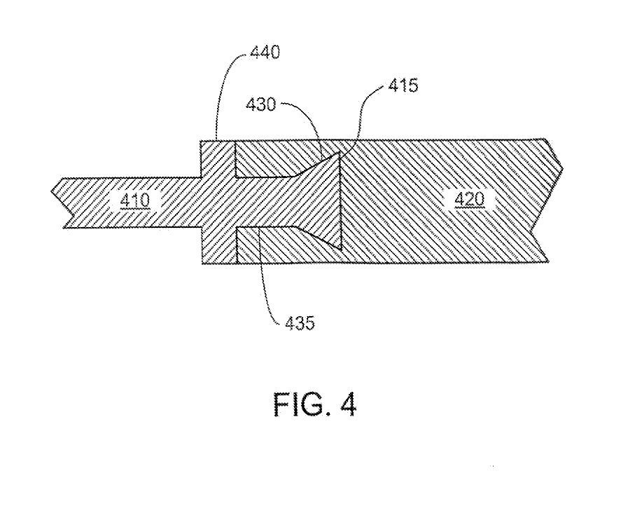

FIG. 4 is a cross-sectional side view of another embodiment of the present invention. In FIG. 4, a non-parallel interface is provided by a continuous ridge 415 around the circumference of the acoustic radiator 410 similar to that shown in FIG. 3. Acoustic radiator 410 may be provided with a positioning ridge 440 to assist alignment of the acoustic radiator in a surround mold. FIG. 4 also illustrates that the non-parallel interface 430 is not limited to being perpendicular to the radiator/surround interface 435 but may be oriented at an acute or obtuse angle to the radiator surround interface 435. FIG. 4 also illustrates that the continuous ridge 415 may be placed at a different radial position within the outer portion of the acoustic radiator than the position shown in FIG. 3. In FIG. 4, the continuous ridge 415 runs along the edge of the acoustic radiator 410 and is part of the edge of the acoustic radiator.

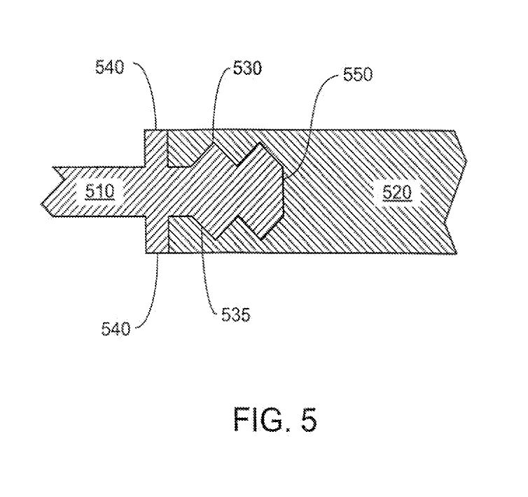

FIG. 5 is a cross-sectional side view of another embodiment of the present invention. In FIG. 5, the acoustic radiator 510 includes a positioning ridge 540 to assist alignment of the acoustic radiator in a surround mold. The positioning ridge 540 may form a continuous ridge on a face of the acoustic radiator. A second positioning ridge may be disposed on the opposite face of the acoustic radiator. The positioning ridge 540 is positioned inward from the radiator's edge 550 and may be used to define the extent of the surround overlap over the outer portion of the acoustic radiator 510. At least one triangular ridge 530 is disposed on a face of the acoustic radiator between the positioning ridge 540 and the edge 550 of the acoustic radiator 510. The triangular ridge 530 may form a continuous ridge around the circumference of the acoustic radiator. In other embodiments, the triangular ridge may be discontinuous and spaced around the circumference of the acoustic radiator. The sides of the triangular ridge 530 provide non-parallel radiator/surround interface 535 when the surround is molded to the acoustic radiator 510.

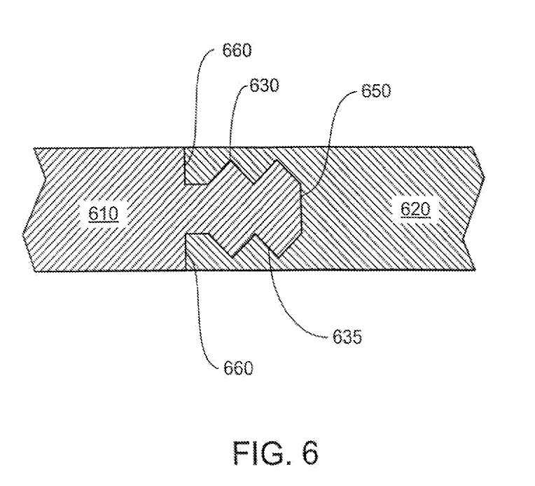

FIG. 6 is a cross-sectional side view of another embodiment of the present invention. In FIG. 6, a shoulder 660 in the acoustic radiator 610 may be used to position the acoustic radiator 610 in the surround mold and defines the extent of the surround overlap over the outer portion of the acoustic radiator 610. At least one protrusion 630 located in the outer portion of the acoustic radiator 610 between the shoulder 660 and edge 650 provides a non-parallel interface 635 to provide a mechanical interference between the acoustic radiator 610 and surround 620.

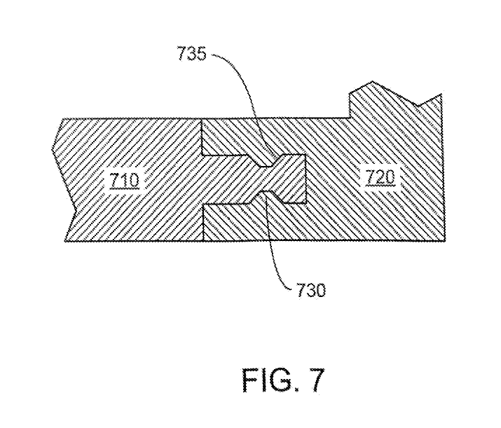

A non-parallel interface may also be created using depressions or grooves in the acoustic radiator. FIG. 7 is a cross-sectional side view of another embodiment of the present invention. In FIG. 7, a mechanical interference between an acoustic radiator 710 and a surround 720 is created by a depression 730 in a face of the acoustic radiator 710. The depression 730 is filled with the surround material during molding, creating a non-parallel interface 735. Depression 730 may be a continuous groove in an outer portion of the acoustic radiator 710 extending circumferentially around the acoustic radiator 710. Depression 730 may also include grooves that extend circumferentially over only a portion of the acoustic radiator 710.

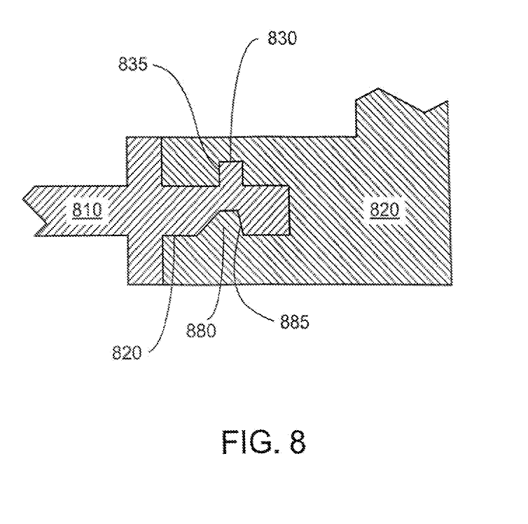

FIG. 8 is a cross-sectional side view of another embodiment of the present invention. FIG. 8 illustrates a combination of protrusions and depressions may be used to mechanically interlock the surround to the acoustic radiator. In FIG. 8, the acoustic radiator 810 includes a protrusion 830 on a first surface of the acoustic radiator 810. The protrusion 830 may be a discrete structure such as, for example, a post. Alternatively, the protrusion may be a continuous ridge encircling the acoustic radiator 810. In FIG. 8, the acoustic radiator 810 includes a depression 880 on a second surface of the acoustic radiator 810. Depression 880 may be a continuous circumferential groove encircling the acoustic radiator 810. Alternatively, depression 880 may be a discrete structure such as, for example, a blind hole. The non-parallel interface 885 of the depression 880 may be oriented to the parallel interface 820 at a different angle than the orientation of the non-parallel interface 835 of the protrusion 830.

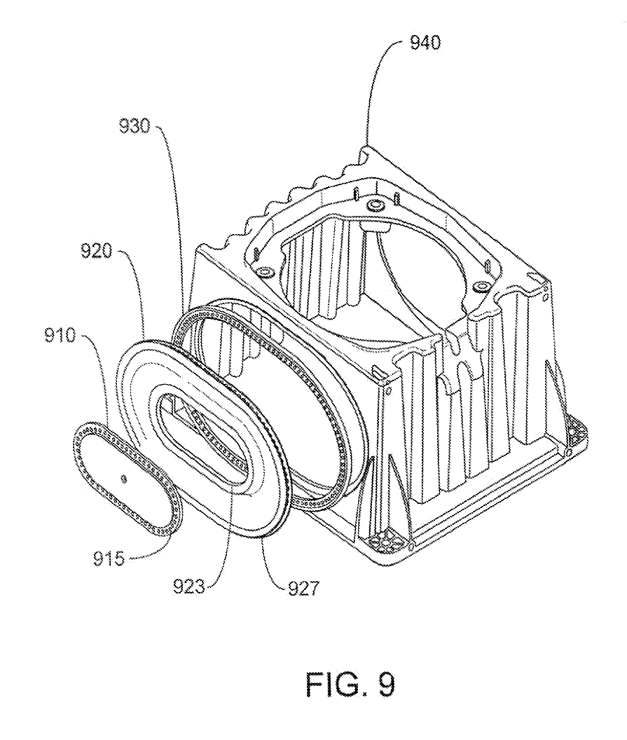

FIG. 9 is an exploded perspective view of an embodiment of the present invention. FIG. 9 illustrates an example where the acoustic driver is a passive radiator and the acoustic radiator is a plate. In FIG. 9, an acoustic radiator 910 is attached to a surround 920 along the surround's inner perimeter 923. The outer perimeter 927 of the surround 920 is attached to a mounting ring 930. The mounting ring 930 enables the radiator/surround/ring assembly to be formed in a separate manufacturing step before being attached to a housing 940.

The assembly may be formed by any of the manufacturing methods known to the skilled artisan. For example, the assembly may be formed by first placing an outer portion of the radiator and the outer ring in a mold having a cavity defining the surround. In some embodiments, the outer portion of the acoustic radiator may be chemically or mechanically surface treated to promote material adhesion to the acoustic radiator. The surround is formed by flowing an elastomer, preferably a thermoplastic elastomer, into the mold and allowing the elastomer to set. The thermoplastic elastomer may any elastomeric material suitable for the surround such as, for example, silicone rubber, polyurethane rubber, or fiber reinforced rubber composites. When the elastomer is flowed into the mold, the elastomer fills any depressions in the surround and flows around any protrusions 915 in the surround to form interfaces that serve to mechanically lock the surround to the radiator. After the elastomer sets, the assembly may be attached to the housing 940 by, for example, ultrasonically welding the mounting ring 930 to the housing 940. Alternative methods include pour casting into a mold using, for example, a two-part thermosetting elastomer.

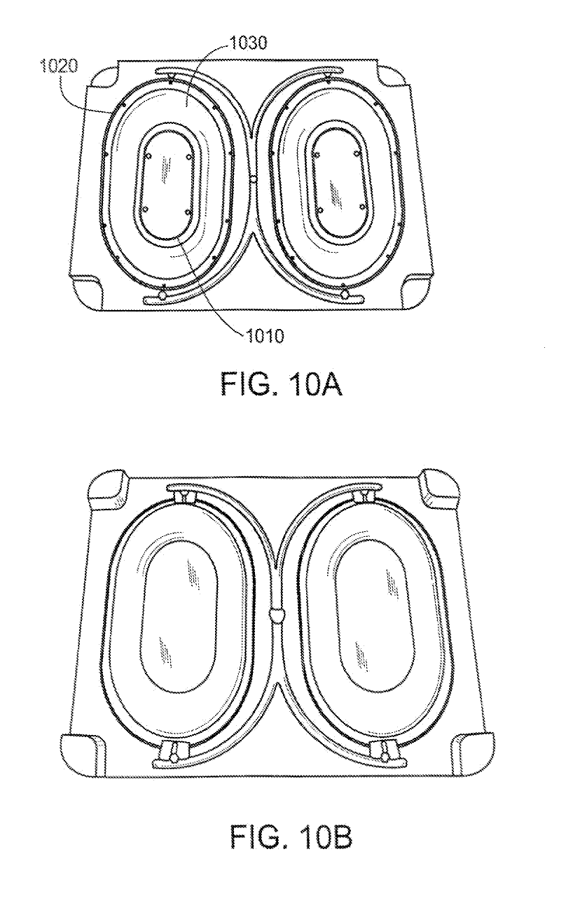

FIG. 10a illustrates the inner surface of a bottom portion of a two-part mold used to form the radiator/surround/ring assembly illustrated in FIG. 9. FIG. 10b illustrates the inner surface of a top portion of a two-part mold shown in FIG. 10a. In FIG. 10a, a first groove 1010 positions the acoustic radiator in the mold. A second groove 1020 positions the mounting ring in the mold. The top portion of the two-part mold is positioned over the bottom portion to form a cavity 1030. An elastomeric material is flowed into the mold, filling the cavity 1030 to form the surround. After setting the elastomeric material, the mold is struck and the radiator/surround/ring assembly is removed. The mold in FIGS. 10a and 10b form two assemblies per mold but molds capable of making any number of assemblies per mold are understood to be within the scope of the present invention.

Having thus described at least illustrative embodiments of the invention, various modifications and improvements will readily occur to those skilled in the art and are intended to be within the scope of the invention. For example, protrusions may have a uniform or non-uniform height. The protrusions can have a variety of shapes. For example, a vertical cross-section of a protrusion may be symmetrical such as a rectangle, a triangle, or a trapezoid, or may be asymmetrical such as a truncated right triangle. Similarly, a horizontal cross-section of a protrusion, parallel to a surface of the outer portion of the acoustic radiator, may be symmetrical such as a circle, a rectangle, a triangle, or a wedge or may be asymmetrical. A protrusion having an azimuthal extent much greater than its radial extent is referred to herein as a ridge wherein the terms azimuthal and radial refer to a cylindrical coordinate reference frame where the cylindrical axis is collinear with the acoustic radiator axis defining the reciprocal motion of the acoustic radiator relative to a housing of the acoustic transducer. A ridge may be a continuous ridge that extends completely around the acoustic radiator. A ridge may be discontinuous and circumferentially extend only a fraction of a full rotation about the acoustic radiator axis. Placement of protrusions may be placed anywhere on the outer portion of the acoustic radiator that is overlapped by the surround. For example, a spiral ridge may be formed by monotonically varying the radial position of the ridge as a function of the azimuthal position. It should be understood that the aforementioned examples illustrate some of the many configurations that would occur to a skilled artisan reading this disclosure and is not intended to limit the scope of the present invention.

Accordingly, the foregoing description is by way of example only and is not intended as limiting. The invention is limited only as defined in the following claims and the equivalents thereto.

What is claimed:

1. An assembly comprising:
an acoustic radiator having a first surface and an outer portion of the first surface, the outer portion having at least one protrusion extending from the first surface, the at least one protrusion characterized by a protrusion surface; and
a surround in contact with the outer portion of the first surface forming a first interface, the surround in contact with the at least one protrusion forming a second interface, wherein the second interface provides a mechanical interference in a radial direction.

2. The assembly of claim 1 wherein the at least one protrusion is a post

3. The assembly of claim 1 wherein the at least one protrusion is a continuous ridge.

4. The assembly of claim 1 wherein the acoustic radiator further comprises a second surface opposite the first surface and at least one protrusion extending from the second surface, the at least one protrusion extending from the second surface in contact with the surround and forming a third interface with the surround, the third interface oriented non-parallel to the first interface.

5. The assembly claim 4 wherein the at least one protrusion extending from the second surface is different from the at least one protrusion extending from the first surface.

6. The assembly of claim 1 wherein the acoustic radiator further comprises a second surface opposite the first surface and at least one depression in the second surface, the at least one depression in contact with the surround and forming a third interface with the surround, the third interface having a non-parallel orientation to the first interface.

7. The assembly of claim 6 wherein the at least one depression is a blind hole.

8. The assembly of claim 6 wherein the at least one depression is a continuous groove.

9. The assembly of claim 1 further comprising an outer ring attached to an outer perimeter of the surround.

10. An assembly comprising:
an acoustic radiator having an outer portion, the outer portion having a first surface and a second surface;
a surround in contact with the first and second surface of the outer portion of the acoustic radiator; and
a first protrusion extending from the first surface of the acoustic radiator, the first protrusion in contact with the surround.

11. The assembly of claim 10 further comprising a second protrusion extending from the second surface of the acoustic radiator, the second protrusion in contact with the surround.

12. The assembly of claim 10 further comprising a depression in the second surface filled by the surround.

13. The assembly of claim 10 wherein the first protrusion is a post.

14. The assembly of claim 10 wherein the first protrusion is a ridge.

15. The assembly of claim 12 wherein the depression is a groove.

16. An assembly manufactured by a process comprising the steps of:
providing an acoustic radiator having an outer portion and at least one protrusion extending laterally from a surface of the outer portion of the acoustic radiator;
placing at least the outer portion of the acoustic radiator in a mold, the mold defining a cavity enclosing the outer portion of the acoustic radiator;
introducing a thermoplastic elastomer into the mold cavity, the thermoplastic elastomer filling the cavity and forming an interface with the surface of the outer portion of the acoustic radiator and with the at least one protrusion; and
removing the assembly from the mold,
wherein the acoustic radiator is mechanically interlinked with a surround, the surround comprising the thermoplastic elastomer introduced into the mold cavity.

17. The assembly of claim 16 wherein the at least one protrusion is a post.

18. The assembly of claim 16 wherein the at least one protrusion is a ridge.

19. The assembly of claim 18 wherein the ridge is radially positioned at an edge of the acoustic radiator.

20. The assembly of claim 16 wherein the outer portion includes at least one depression.

21. The assembly of claim 20 wherein the depression is a blind hole.

22. The assembly of claim 20 wherein the depression is a groove.

23. The assembly of claim 22 wherein the groove is continuous.
